(19) United States
(12) Patent Application Publication
(10) Pub. No.: US 2017/0264608 A1
(43) Pub. Date: Sep. 14, 2017

(54) VISUAL BIOMETRIC AUTHENTICATION SUPPLEMENTED WITH A TIME-BASED SECONDARY AUTHENTICATION FACTOR

(71) Applicant: QUALCOMM Incorporated, San Diego, CA (US)

(72) Inventors: Reese Moore, San Diego, CA (US); Stephen Groat, San Diego, CA (US)

(21) Appl. No.: 15/065,060

(22) Filed: Mar. 9, 2016

(51) Int. Cl. H04L 29/06

(52) U.S. Cl. CPC H04L 63/0861; H04L 63/10; H04L 63/06

(57) ABSTRACT

Various features pertain to two-factor authentication. A user seeking access to the secure facility or system generates a time-limited Quick Response (QR) code with his or her smartphone for display on a touchpad screen of the smartphone. The user presents the display of the QR code to a video camera of an authentication system that controls access to the secure facility or system. The video camera captures both the QR code on the smartphone screen and an image of the user. The authentication system then identifies the user based on a biometric analysis of the image of the user and confirms the authentication by verifying that the QR code corresponds to an authorized user. The QR code may be generated based on a secret key stored within the smartphone and the current date/time, with valid authorization limited to a narrow time window following generation of the QR code. Alternatively, the authentication code may be continuously or periodically transmitted as an infrared signal (IR) by a device such as smart glasses.

### BACKGROUND

Field

The present disclosure pertains to two factor authentication (2FA) employing visual biometric authentication as one of the authentication factors.

Background

Visual biometric authentication may be employed by secure access systems to authenticate personnel seeking access to secure facilities. Visual biometric authentication may also be used to authenticate users seeking to access secure devices or systems such as automated teller machines (ATMs) and the like. Such secure access systems may employ a video camera biometric entry system whereby the video camera records an image of the individual and attempts to verify the identity of the individual using facial recognition or other forms of visual biometric authentication. However, visual biometric authentication, on its own, can be a relatively weak form of authentication (e.g., simple facial recognition systems might be compromised by presenting a static photo of an authorized user). Accordingly, such systems often require a second form of authentication, such as manual entry by the user of a keypad code or personal identification number (PIN). That is, a form of two factor authentication (2FA) is employed where the second factor is a simple manually-entered keycode or the like. In many cases, it would be desirable to provide authentication systems that do not require manual entry of a keypad code as the second form of authentication since that imposes an extra burden on the user and may slow access to a facility or system, which can be particularly burdensome for secure facilities where numerous employees may need quick and efficient access. In addition, systems employing a simple keypad code as a second form of authentication can be compromised if an imposter obtains the code (perhaps by eavesdropping) and also obtains a photo of the user. The imposter could then display the photo of the user to the video camera and enter the keypad code to gain access that might compromise the secure system or facility.

Hence, it would be desirable to provide a different, more efficient and more trustworthy form of two factor authentication, particularly for use with video camera-based secure access systems or similar authentication systems.

### SUMMARY

A method for use by an authentication system for authenticating a user includes: capturing biometric indicia of a user by using a remote imaging device; obtaining an identifier code from a portable device of the user that identifies an authenticated user of the portable device, the identifier code obtained remotely; performing biometric authentication of the user based on the biometric indicia of the user captured by the remote imaging device; and confirming authentication of the user based on the identifier code obtained remotely from the portable device.

In another aspect, an authentication system includes: an imaging device operative to remotely capture biometric indicia of a user: an identifier code input device operative to remotely obtain an identifier code from a portable device of the user that identifies an authenticated user of the portable device; and a processing circuit operative to perform biometric authentication of the user based on the biometric indicia of the user captured by the imaging device, and confirm authentication of the user based on the identifier code obtained from the portable device.

In yet another aspect, a non-transitory machine-readable storage medium has one or more instructions which when executed by a processing circuit causes the processing circuit to: capture biometric indicia of a user by using a remote imaging device; obtain an identifier code from a portable device of the user that identifies an authenticated user of the portable device, the identifier code obtained remotely; perform biometric authentication of the user based on the biometric indicia of the user captured by the remote imaging device; and confirm authentication of the user based on the identifier code obtained remotely from the portable device.

### DRAWINGS

Various features, nature, and advantages may become apparent from the detailed description set forth below when taken in conjunction with the drawings in which like reference characters identify correspondingly throughout.

FIG. 1 illustrates a two factor authentication scheme using a keycode.

FIG. 2 illustrates a two factor authentication scheme using a smartphone-displayed QR code.

FIG. 3 summarizes a procedure for authenticating a user using the two factor authentication scheme of FIG. 2.

FIG. 4 is a block diagram illustrating components of a smartphone and an authentication system that exploits a smartphone-displayed QR code.

FIG. 5 illustrates exemplary operations of the components of FIG. 4 and information exchanged there-between.

FIG. 6 is a block diagram illustrating components of a smartphone, a local authentication system and a remote authentication system that exploit a smartphone-displayed QR code.

FIG. 7 illustrates exemplary operations of the components of FIG. 6 and information exchanged there-between.

FIG. 8 is a block diagram illustrating an example of a hardware implementation for an apparatus employing a processing system that may exploit the systems, methods and apparatus of FIGS. 2-7.

FIG. 9 is a flow diagram broadly illustrating exemplary operations performed by an authentication system.

FIG. 10 is a flow diagram illustrating exemplary operations performed by a stand-alone authentication system.

FIG. 11 is a flow diagram illustrating exemplary operations performed by a local authentication system for use with a remote authentication system.

FIG. 12 is a flow diagram broadly illustrating exemplary operations performed by a portable user device for use with an authentication system.

FIG. 13 is a flow diagram broadly illustrating exemplary operations performed by a remote authentication system for use with a local authentication system.

FIG. 14 is a flow diagram further illustrating exemplary operations performed by an authentication system and a portable user device.

FIG. 15 is a block diagram illustrating exemplary components of an authentication system.

FIG. 16 is a block diagram illustrating exemplary components of smartphone or other portable user device.

FIG. 17 illustrates an alternative two factor authentication scheme using an authentication code transmitted by smart glasses or other suitable portable devices.

FIG. 18 is a block diagram illustrating exemplary components of smart glasses or other portable user devices for use with the alternative system of FIG. 17.

FIG. 19 is a flow diagram further illustrating exemplary operations performed by an authentication system and a smart glasses portable user device.

### DETAILED DESCRIPTION

In the following description, specific details are given to provide a thorough understanding of the embodiments. However, it will be understood by one of ordinary skill in the art that the embodiments may be practiced without these specific detail. For example, circuits may be shown in block diagrams in order not to obscure the embodiments in unnecessary detail. In other instances, well-known circuits, structures, and techniques may not be shown in detail in order not to obscure the embodiments.

### Overview of 2FA Systems

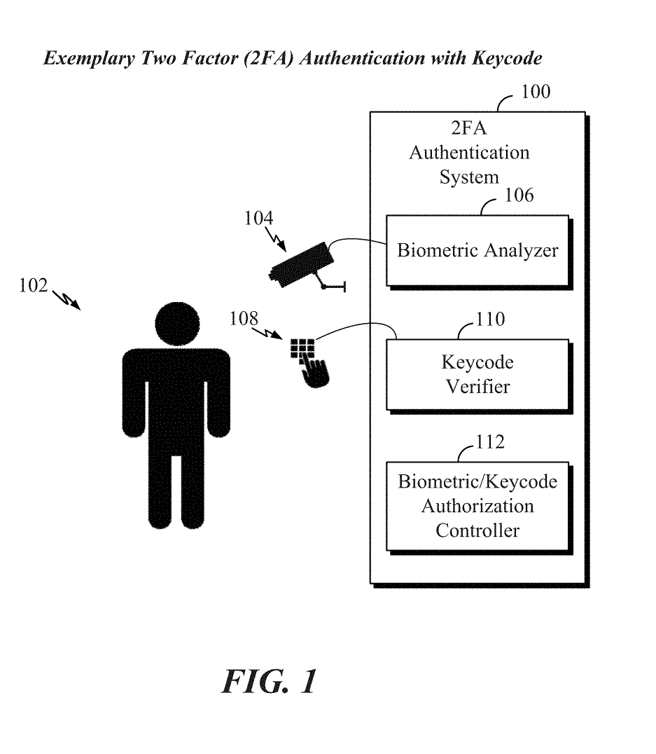

FIG. 1 illustrates an exemplary two factor authentication (2FA) system 100 employing visual biometric authentication as one of the authentication factors along with manual user keycode entry. A user 102 seeking access to a secure system or area is imaged by a video camera 104, which relays images of the user to a biometric analyzer 106 that seeks to confirm the identity of the user as an authorized user based on biometric indicia within the images of the user. The user also enters a keycode into a keypad 108, which is relayed to a keycode verifier 110 that verifies the identity of the user based on the keycode (e.g. by verifying the keycode corresponds to a valid keycode for the user). A biometric/keycode authorization controller 112 then determines whether the user 102 is authorized to access the secure system. Note that the secure system may include a secure facility, computing system, apparatus or device, etc. A secure facility may be an installation containing sensitive information such as a military or corporate installation or the like. A secure computing system may be an automated teller (ATM) system or other financial transaction system. Alternate forms of secondary authentication other than a keycode entry device may include a key swipe device for receiving an employee identification (ID) keycard, a credit card, a bankcard, or the like.

As noted above, in many cases, it would be desirable to provide authentication systems that do not require manual entry of a keypad code as the second form of authentication since that imposes an extra burden on the user and may slow access to a facility, which can be particularly burdensome for secure facilities where numerous employees may need to gain efficient access to the facility. In addition, systems employing a simple keypad code as a second form of authentication can be compromised if an imposter obtains the code (perhaps by eavesdropping) and also obtains a photo of the user. The imposter could then display the photo of the user to the video camera and enter the keypad code to gain access. Systems employing a key swipe device can be compromised if the imposter steals the keycard from an authorized user and swipes the keycard while presenting a photo of the user to the video camera.

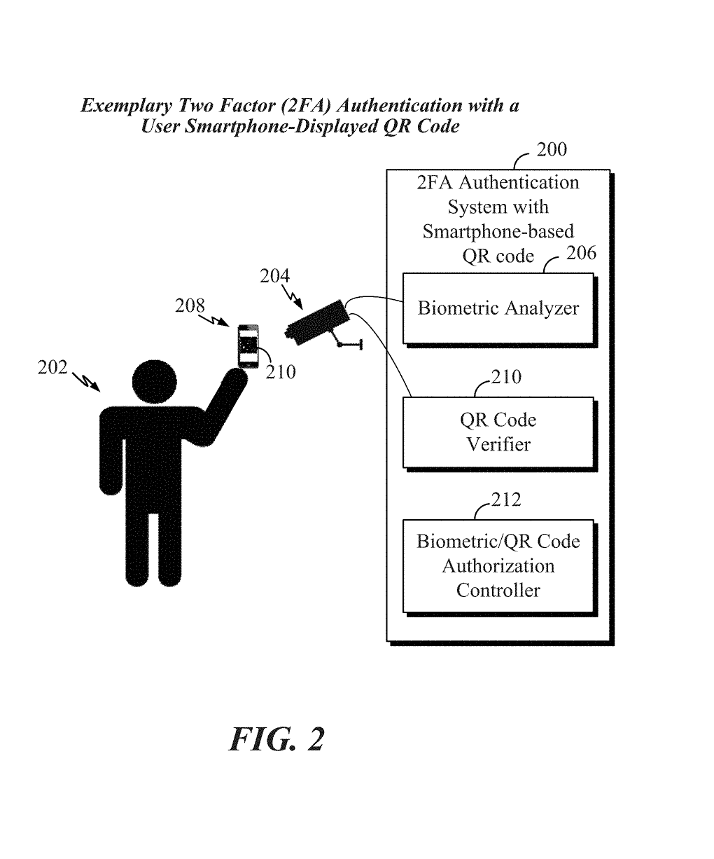

FIG. 2 illustrates an exemplary 2FA system 200 employing visual biometric authentication along with QR-code authentication where a smartphone of the user displays a time-limited QR identifier code generated for the user based on a security key stored within the smartphone. That is, in this example, a user 202 seeking access to the secure facility or system is imaged by a video camera 204, which relays an image of the user to a biometric analyzer 206 that seeks to confirm the identity of the user as an authorized user based on biometric indicia within the image of the user. The user 202 also displays the time-limited QR code 207 via a smartphone 208 carried by the user for concurrent imaging by the video camera 204. The QR code is relayed to a QR code verifier 210 that seeks to confirm the identity of the user based on the QR code (e.g. by verifying that the QR code corresponds the same user identified by the biometric analyzer). A biometric/QR code authorization controller 212 then determines whether the user 102 is authorized to access the secure facility or system based on the biometric analysis, the QR code verification, and whether QR code is sufficiently fresh (i.e. whether the QR code was received by system 200 within a permissible time-window).

Alternate forms of secondary authentication other than a QR code include coded audio signals, coded infrared (IR) signals or the like. Moreover, note that a local authentication system (such as an ATM) may operate in conjunction with a remote system that performs the actual authentication. For example, the local system may forward the video camera images to a remote system that performs the biometric analysis and extracts the QR code from the captured images to authenticate the user. The remote system sends a suitable message to the local system that either confirms or disconfirms authentication. In this manner, each individual local authentication system need not be equipped to perform all aspects of the overall authentication process.

In practice, when a user attempts to authenticate to an authentication system such as the one of FIG. 2, the user first accesses an application (app) on a smartphone or other portable device carried by the user that he or she has already been authenticated to. The smartphone then generates and displays the QR code image (or other suitable visual authentication identifier code or image), which is generated by the smartphone using a key securely stored in the smartphone and using the current date/time. The user then holds up the smartphone to the video camera to present the QR image alongside their face (or alongside whatever visual biometric markers would otherwise need to be presented). The system 200 then extracts visual biometric indicia for the user and also validates that the QR visual authentication image was generated using the user's device/key at a sufficiently recent time, e.g. within the last ten or twenty seconds.

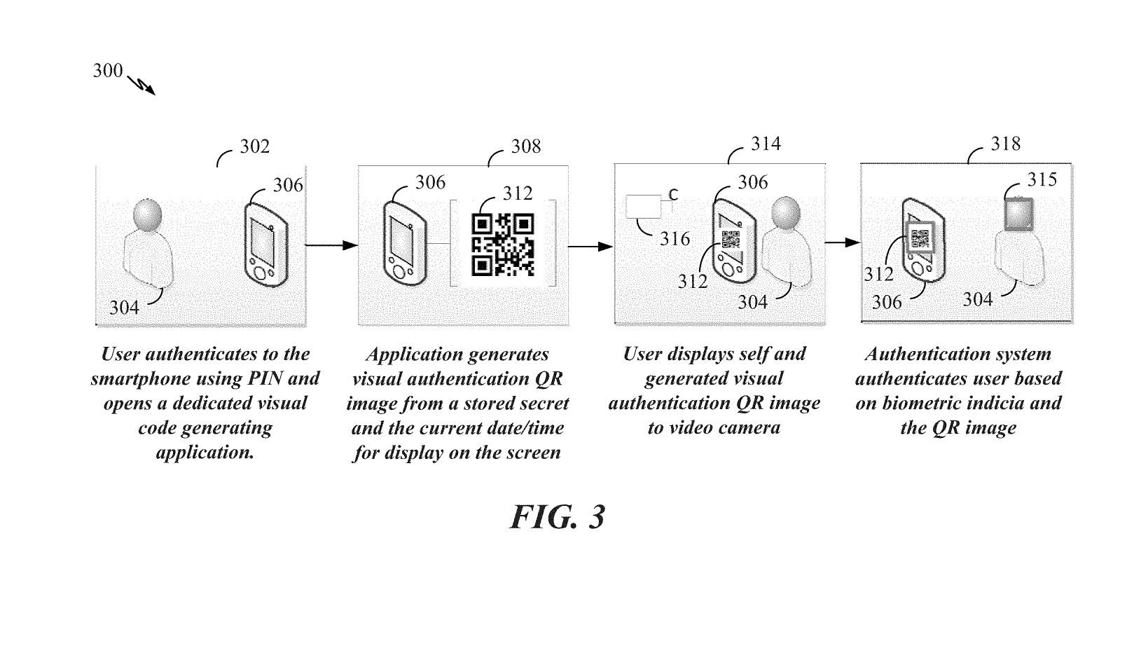

FIG. 3 illustrates an overall procedure 300 including QR generation. In panel 302, a user 304 authenticates to the smartphone 306 using a PIN and opens a dedicated visual code generating application (app) or program. In panel 308, the app generates a visual authentication QR image 312 from a stored secret (such as a private key) and the current date/time for display on the display screen of the smartphone 306. In panel 314, the user 304 displays himself or herself along with the visual authentication QR image 312 to a video camera 316 of an authentication system. In panel 318, the authentication system (such as system 200 of FIG. 2) authenticates the user based on the biometric indicia within an image 315 of the user and the generated QR image 312.

The access systems and procedures of FIGS. 2 and 3 may thereby eliminate or at least reduce the need for a manual keypad entry system (as in FIG. 1) or may be used to provide an extra layer of security in addition to keypad or key swipe entry. Moreover, the manner by which the user first authenticates to the smartphone application to generate the QR image may be more sophisticated and trustworthy than a simple keycode entry. For example, the smartphone application may require fingerprint authentication, iris authentication or other trustworthy forms of authentication that a simple manual keypad mounted to the secure entry system would lack. Still further, by generating the QR image in conjunction with the current date/time, an unauthorized user cannot merely obtain a matching QR image in advance and present it to the access system. Rather, reach QR image is time-limited and, depending upon the embodiment, might be valid for only ten or twenty seconds. Note that QR images represent just one example of a suitable visual authentication image. In other examples, an encoded audio signal, rather than an encoded visual pattern, is used. IR transmission of coded signal patterns may also be employed, if the access system is equipped to receive IR signals. Hence, the techniques described herein are not limited to access systems employing video cameras and are not limited to authentication devices equipped with visual displays. Note also that a smartphone is just one example of a suitable portable user device. Other examples include smartwatches, smart eyeglass devices, portable communication devices, mobile phones, personal digital assistants (PDAs), user equipment (UE) and/or tablet computers.

### Exemplary Operating Environments

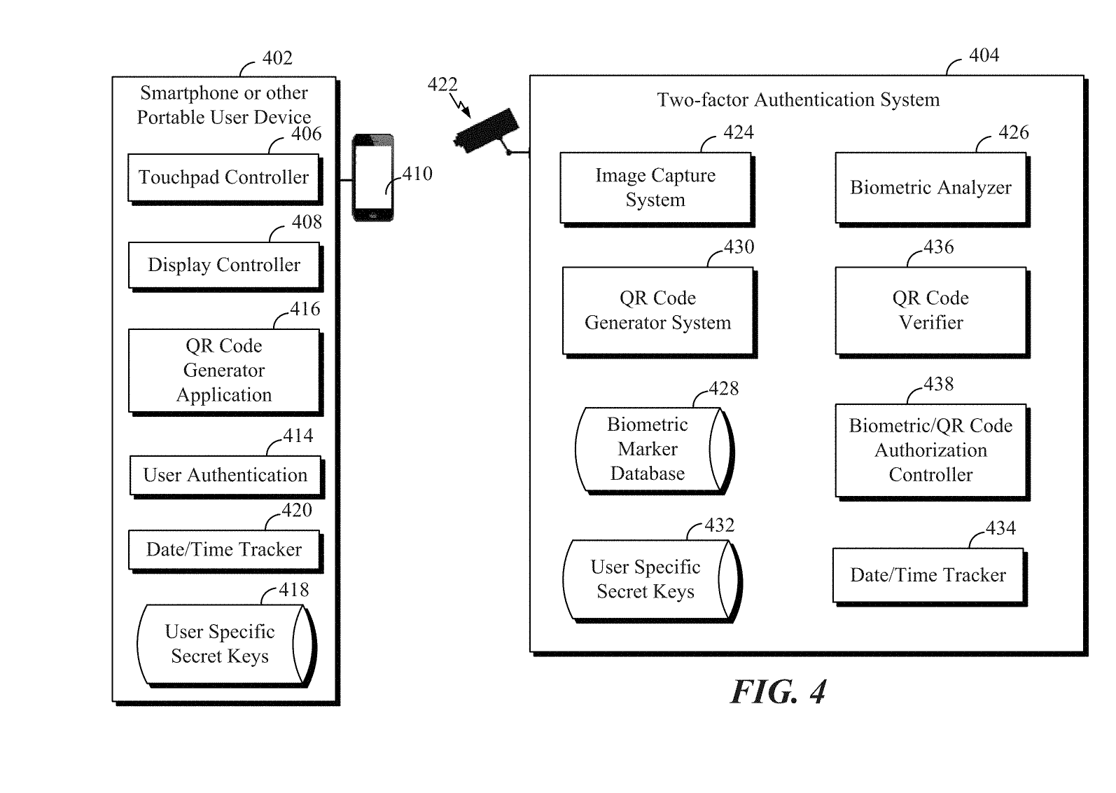

FIG. 4 illustrates a first exemplary operating environment including a smartphone 402 or other portable user device, which is employed by the user to gain access to a secure system or facility via a two-factor authentication system 404. Only selected components of the smartphone 402 and the authentication system 404 are shown. In this example, the smartphone 402 includes a touchpad controller 406 for inputting commands, fingerprints or other inputs from a touchpad display 410 of the device, which is controlled by a display controller 408. To authenticate to the authentication system 404 (which has already been programmed to recognize the user as an authorized user via an initial setup procedure, discussed below), the user begins by authenticating himself or herself to the smartphone 402 under the control of a user authentication controller 414. For example, the user may be required to enter a fingerprint via the touchpad display 410 to authenticate the user to the smartphone or to a particular app running on the smartphone. A QR code generator application (app) or controller 416 then generates a time-limited QR identifier code based on one or more previously-stored user specific secret keys stored in a database 418 and based on the current date/time as determined by a data/time tracker 420. The time-limited QR code is then displayed on the touchpad display 410 of the smartphone and presented by the user to a video camera 422 (or other imaging system) of the authentication system 404 along with the face of the user (or other suitable biometric indicia), as already explained.

An image capture system 424 of the authentication system 404 concurrently captures an image of the QR code presented on the smartphone and the face of the user (or other presented biometric indicia). Depending upon the system, the image(s) captured may be still images or moving images. In some examples, multiple imaging systems may be used rather than a single video camera. A biometric analyzer 426 then seeks to identify the user based on biometric indicia within the captures user image(s) by comparing the indicia with previously stored biometric markers for all authorized users, previously stored within a biometric marker database 428. If the user is not identified based on the biometric indicia, access is denied (or, depending upon the system, the user may need to provide an alternative form of authentication to the system such as by providing a fingerprint directly to a fingerprint reader, not shown, of the authentication system).

Assuming the authentication system recognizes and identifies the user based on the biometric indicia in the captured images, a QR code generator system or program 430 (which may be similar to the corresponding QR code generator of the smartphone), generates a QR code for comparison to the one displayed on the smartphone and captured by the video camera 422. For example, based on the identity of the user, the QR code generator 430 may look up a corresponding secret key for that particular user as previously stored within a user specific secret key database 432 during an initial setup procedure. Then, using the appropriate key for the identified user, the date/time that the QR code was presented by the user, and the date/time as tracked by a date/time tracker 423 of the authentication system 404, the QR code generator 430 generates a QR code for comparison against the QR code presented by the user. Assuming the QR code presented by the user is suitably fresh (i.e. it was generated within a predetermined acceptable time window), the QR code generated by the authentication system 404 should match the QR code presented by the user, as verified by a QR code verifier 436. If verification is achieved, then a biometric/QR code authorization controller 438 authorizes the user to access the secure system or facility. For example, if the authentication system 404 controls entry to a secure installation, a door to the installation is then unlocked for the user. If the authentication system 404 controls access to an ATM or the like, the user may then be presented with suitable menus on the ATM for withdrawing money or performing other financial transactions.

Insofar as the initial setup is concerned, any suitable procedure may be employed for recording biometric markers for each authorized user for storage in the biometric marker database 428 of the authentication system 404. For example, if the system is intended to control access to a secure facility, each employee granted access to the facility may have their biometric indicia recorded on the date when first granted access, from which biometric markers are derived or extracted. This may be achieved by having security personnel take suitable photographic images or the like of the employee. At that time, a key exchange may be performed with the user's smartphone—such as a public key/private key exchange—so that suitable keys can be stored both in the smartphone and the authentication system. If the authentication system 404 is instead intended to control access to an ATM or the like, each new customer may have their biometric markers obtained and recorded on the date their bank account is opened. A key exchange is performed with the user's smartphone at that time so that suitable keys may be stored both in the smartphone and the authentication system that controls the ATM. For access to ATM's or other widely distributed devices or machines, rather than storing biometric databases within each ATM, it may be more practical and efficient to have a centralized server or other remote system control access to each ATM of the system, as will be described in greater detail below. Hence, in some examples, such as the example of FIG. 4, the authentication system is a local system that includes all components needed to authorize access for users to that local system. In other examples, the authentication system may include local components (such as ATMs) that are in communication with remote components (such as a centralized authorization server).

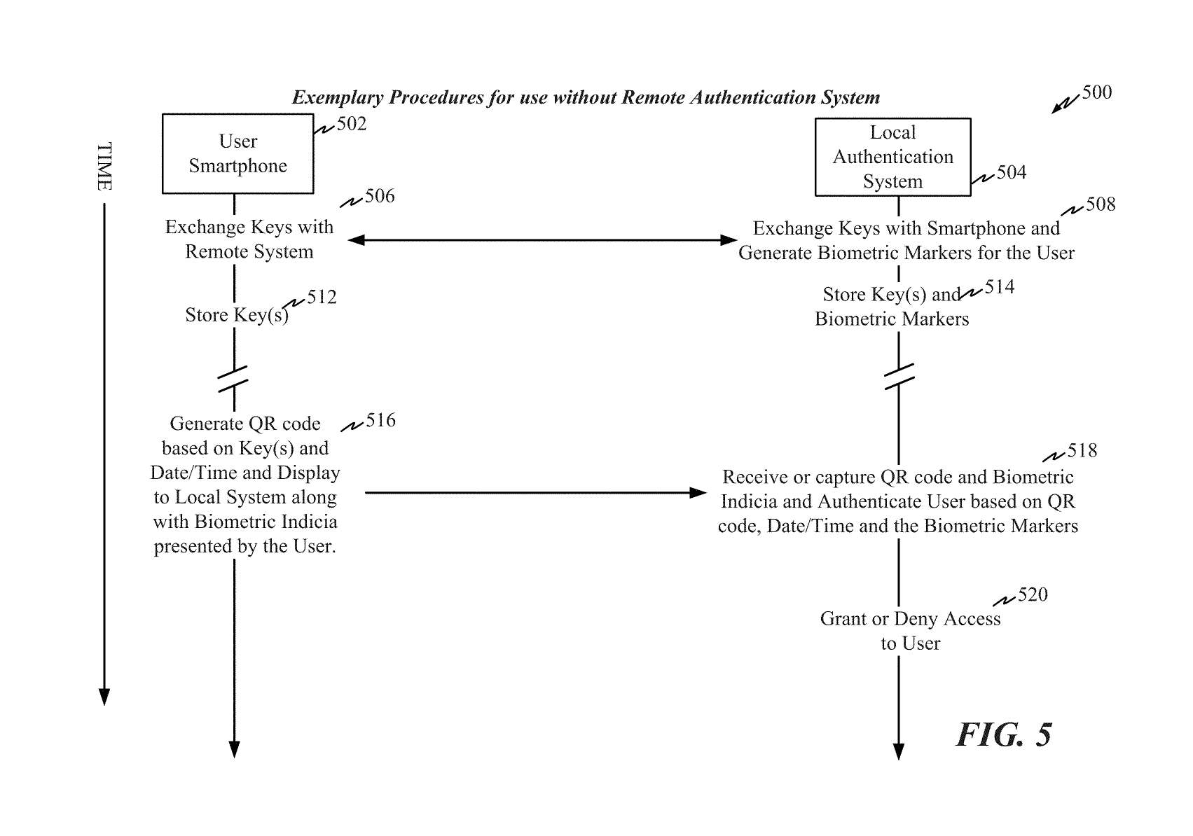

FIG. 5 is a timing diagram 500 illustrating and summarizing exemplary operations of a smartphone 502 or other portable user device and a local authentication system 504, such the authentication system of FIG. 4, and also illustrating information and signals exchanged there-between. During an initial setup procedure, at 506 and 508, the smartphone and authentication system exchange keys. In this example, the authentication system 504 also generates biometric markers for the user such as by, for example, taking images of the user with a video camera (such as the one shown in FIG. 4) from which biometric are extracted and biometric markers are derived. At 512, the smartphone stores its key or keys and, at 514, the authentication system stores its key or keys along with the biometric markers for the user. Sometime later, at 516, when the user needs access, the smartphone generates a QR identifier code based on the previously-stored key(s) and the date/time and displays the QR code. The user presents the QR code to the authentication system 504 along with biometric indicia (e.g. the user presents his or her face to a video camera, as already described). At 518, the authentication system 504 receives or captures the QR code and the biometric indicia and authenticates the user based on the QR code, the date/time and the previously-stored biometric markers. At 520, the authentication system grants or denies access to the user.

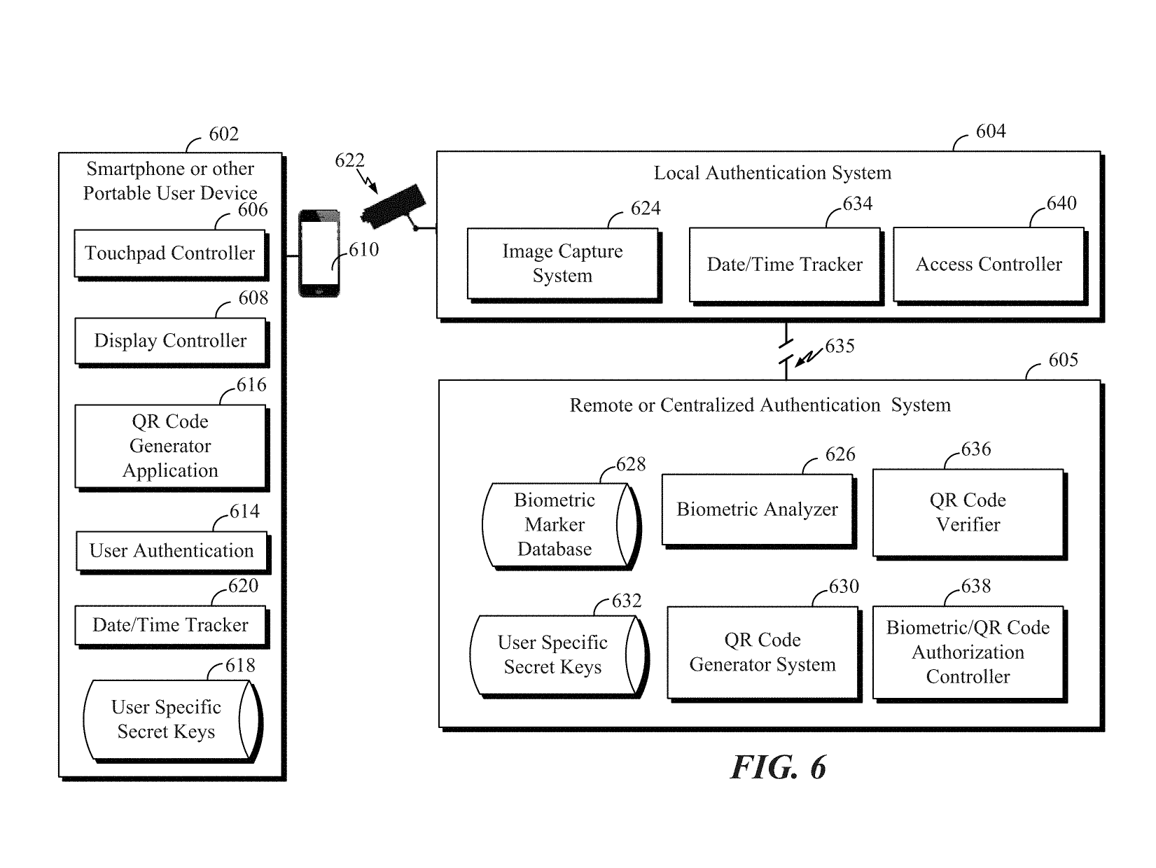

FIG. 6 illustrates a second exemplary operating environment including a smartphone 602 or other portable device, which is employed by the user to gain access to a local secure system or facility via a local authentication system 604 that is operating in conjunction with a remote or centralized authentication system 605. Many of the features of FIG. 6 are similar to those of FIG. 4 and will not be described again in detail. Again, only selected components are shown. In this example, the smartphone 602 again includes a touchpad controller 606 for use with a touchpad display 610 of the device, which is controlled by a display controller 608. To access the local authentication system 604, the user begins by authenticating himself or herself to the smartphone 602 under the control of a user authentication controller 614. A QR code generator application (app) 616 generates a time-limited QR identifier code based on previously-stored user specific key(s) stored in a database 618 of the smartphone and based on the current date/time as tracked by a data/time tracker 620. The QR code is displayed on the smartphone display 610 and presented to a video camera 622 of the local authentication system 604 along with the user's face (or other suitable biometric indicia).

An image capture system 624 of the local authentication system 604 captures image(s) of the QR identifier code and the face of the user (or other biometric indicia). The image(s), the QR code and the current date/time (as tracked by date/time tracker 634) are sent via any suitable transmission connection line or media 635 to the remote authentication system 605. For example, the data may be relayed via the Internet. A biometric analyzer 626 of the remote system 605 then seeks to identify the user based on biometric indicia within the image(s) by extracting the indicia and then comparing the indicia with previously stored biometric markers for all authorized users, as stored within a biometric marker database 628. Assuming the remote system 605 recognizes the user based on the biometric indicia/markers, a QR code generator 630 (which may be similar to the corresponding QR code generator of the smartphone), generates a QR code for comparison with the one received from the local system 604. As already explained, the QR code generator 630 may look up a corresponding secret key for the identified user within a user specific secret key database 632. Then, using the appropriate key for the identified user and the date/time received from the local system 604, the QR code generator 630 of the remote system generates a QR code for comparison against the QR code received from the local system. Assuming the QR code presented by the user was generated within a predetermined acceptable time window, the QR code generated by the remote authentication system 605 should match the QR code presented by the user, as verified by a QR code verifier 636. If verification is achieved, then a biometric/QR code authorization controller 638 generates a signal for authorizing the user to access the local secure system or facility controlled by the local authentication system. The signal is sent to the local system where an access controller 640 responds by granting access to the user, such as by presenting suitable menus on an ATM or other local access device controlled by the local authentication system 604.

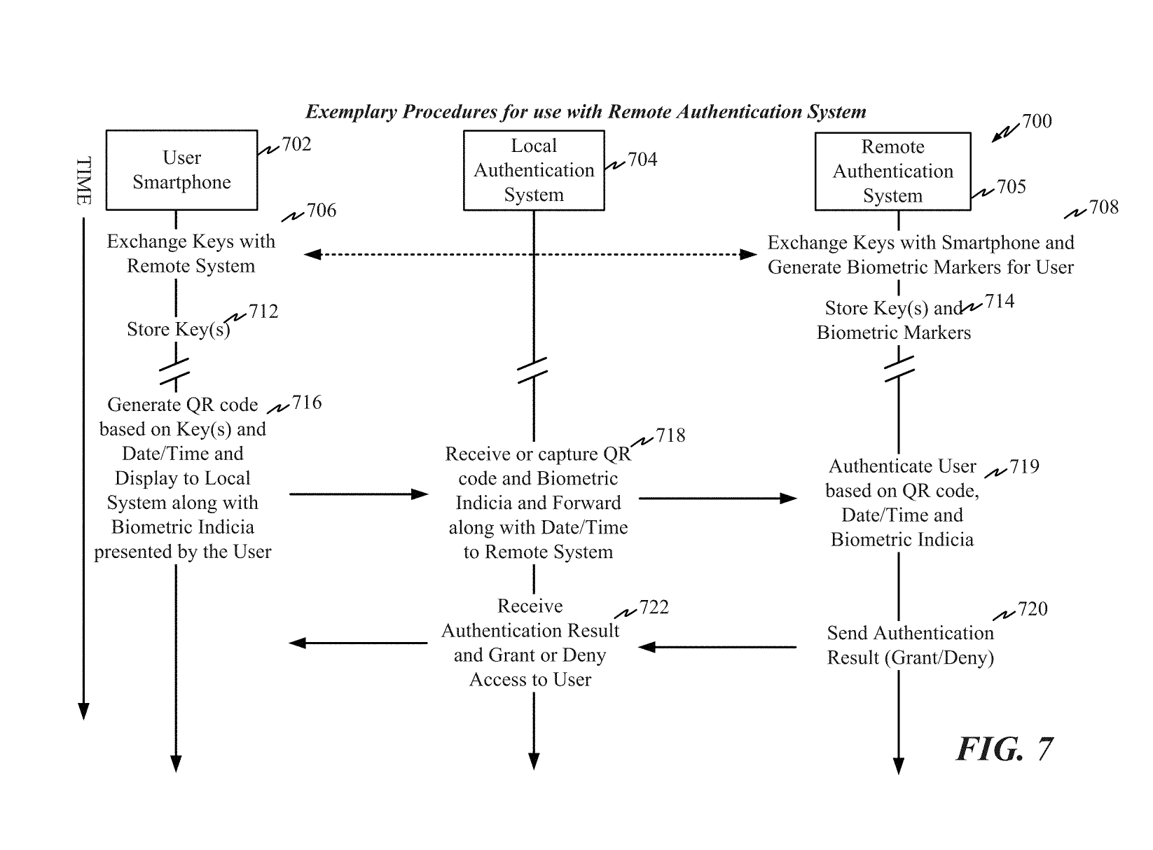

FIG. 7 is a timing diagram 700 illustrating and summarizing exemplary operations of a smartphone 702, a local authentication system 704 and a remote user authentication system 705, such the remote system of FIG. 6, and also illustrating information and signals exchanged there-between. During an initial setup procedure, at 706 and 708, the smartphone and the remote authentication system exchange keys. In this example, the remote authentication system 705 also generates biometric markers for the user such as by, for example, deriving, extracting or otherwise generating the markers by analyzing images of the user obtained from the user by suitably trained personnel. In the case where the user is a new bank customer, the personnel may take images of the customer when he or she first opens a bank account. The images are relayed to the remote authentication system 705 for generation of the biometric markers for the customer. At 712, the smartphone stores its key(s) and, at 714, the remote system 705 stores its key(s) along with the biometric markers for the user. Later, when the user needs access to a secure system or facility controlled by the local authentication system 704, the smartphone generates a QR identifier code at 716 based on its stored key(s) and the current date/time and displays the QR code to a video camera of the local system 704. The user also presents suitable biometric indicia to the video camera (such as the face of the user) alongside the smartphone. At 718, the local system 704 receives or captures the QR code and the biometric indicia and forwards that data along with the current date/time to the remote system 705. At 719, the remote system 705 authenticates the user based on the received QR code, date/time and biometric indicia, as already explained. At 720, the remote system 705 then sends the authentication result (i.e. grant or deny) to the local system 704, which then grants or denies access to the user, at 722.

Thus, various examples have been described with reference to FIGS. 2-7 that use QR codes as a visual identifier code. Additionally or alternatively, systems and procedures may be provided that use other forms of identifier codes. For example, other visual codes may be employed such as other two-dimensional bar codes. Non-visual codes may be employed such as coded audio signals or coded electromagnetic (EM) signals including coded infrared (IR) signals or coded non-IR EM signals (i.e. EM signals outside the IR spectrum). Non-visual identifier codes may be particularly useful for use with user devices that do not have a large display for displaying a QR code to a video camera with sufficient size and resolution to allow the video camera to reliably capture the QR code displayed thereon. As such, non-visual codes may be particularly useful for use with smart eyeglasses (that might not have an outwardly-facing display) or for use with smartwatches with very small displays. Moreover, as noted, the authentication systems described herein may be provided with additional or alternative equipment for allowing or confirming user authentication, such as keypads or key swipe devices or other types of biometric readers, such as fingerprint readers or iris readers.

### Exemplary Systems and Methods

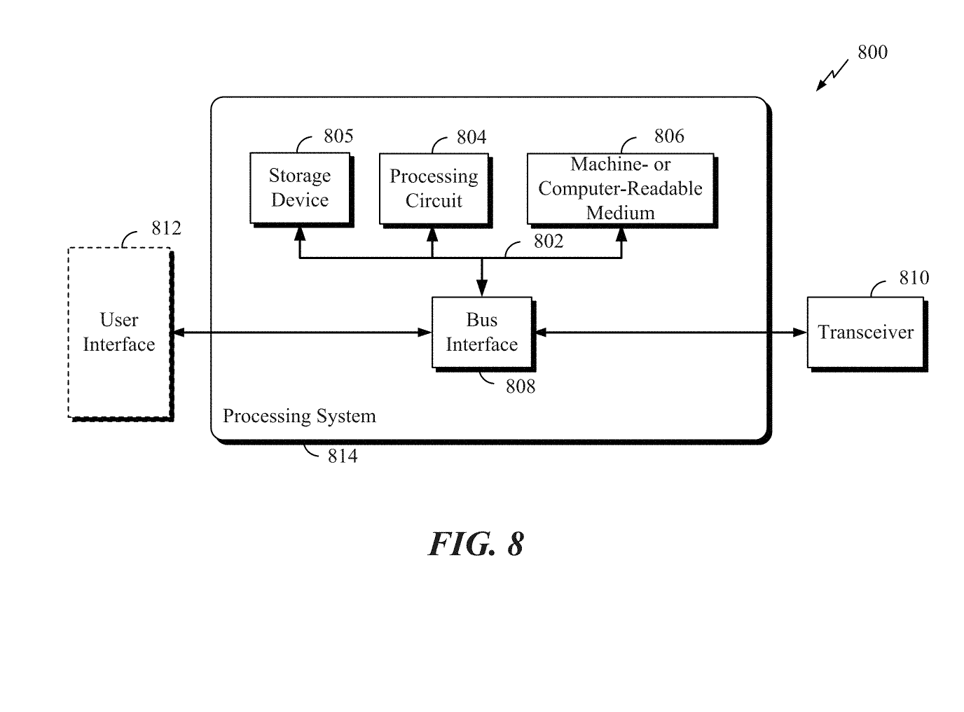

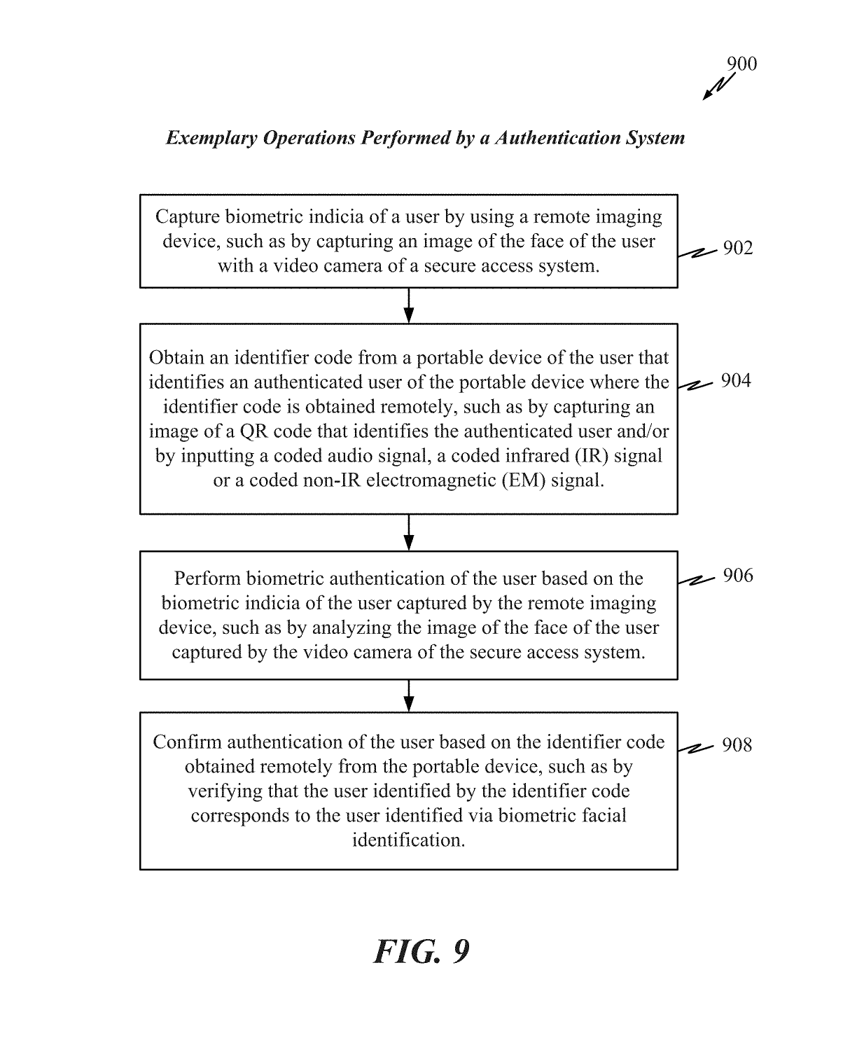

FIG. 8 illustrates an overall system or apparatus 800 in which the systems, methods and apparatus of FIGS. 2-7 may be implemented. In accordance with various aspects of the disclosure, an element, or any portion of an element, or any combination of elements may be implemented with a processing system 814 that includes one or more processing circuits 804. For example, apparatus 800 may be a user equipment (UE) of a mobile communication system or other portable user device or the apparatus may be an authentication system controlling access to a secure system, facility or facility. Apparatus 800 may be used with a radio network controller (RNC). In some examples, a processing circuit 804 of the processing system 814 is implemented as a system-on-a-chip (SoC). Other examples of processing circuits 804 include microprocessing circuits, microcontrollers, digital signal processing circuits (DSPs), field programmable gate arrays (FPGAs), programmable logic devices (PLDs), state machines, gated logic, discrete hardware circuits, and other suitable hardware configured to perform the various functionality described throughout this disclosure. Still further, the processing system 814 could be have distributed components with some components installed within a local authentication system and other components installed within a remote or centralized server such as the remote authentication system of FIG. 6. That is, the processing circuit 804, as utilized in the apparatus 800, may be used to implement any one or more of the systems or processes described above and illustrated in FIGS. 2, 3, 4, 5, 6 and 7 (and those illustrated in FIGS. 9, 10, 11, 12, 13, 14, 15, 16, 17, 18 and 19, discussed below).

In the example of FIG. 8, the processing system 814 may be implemented with a bus architecture, represented generally by the bus 802. The bus 802 may include any number of interconnecting buses and bridges depending on the specific application of the processing system 814 and the overall design constraints. The bus 802 links various circuits including one or more processing circuits (represented generally by the processing circuit 804), the storage device 805, and a machine-readable, processor-readable, processing circuit-readable or computer-readable media (represented generally by a non-transitory machine-readable medium 806.) The bus 802 may also link various other circuits such as timing sources, peripherals, voltage regulators, and power management circuits, which are well known in the art, and therefore, will not be described any further. The bus interface 808 provides an interface between bus 802 and a transceiver 810. The transceiver 810 provides a means for communicating with various other apparatus over a transmission medium. Depending upon the nature of the apparatus, a user interface 812 (e.g., keypad, display, speaker, microphone, joystick) may also be provided. The processing circuit 804 is responsible for managing the bus 802 and for general processing, including the execution of software stored on the machine-readable medium 806. The software, when executed by processing circuit 804, causes processing system 814 to perform the various functions described herein for any particular apparatus. Machine-readable medium 806 may also be used for storing data that is manipulated by processing circuit 804 when executing software.

One or more processing circuits 804 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 806. The machine-readable medium 806 may be a non-transitory machine-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 806 may reside in the processing system 814, external to the processing system 814, or distributed across multiple entities including the processing system 814. The machine-readable medium 806 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system. For example, the machine-readable storage medium 806 may have one or more instructions which when executed by the processing circuit 804 causes the processing circuit to: capture biometric indicia of a user with a remote imaging device; obtain an identifier code from a portable device of the user that identifies an authenticated user of the portable device, the identifier code obtained remotely; perform biometric authentication of the user based on the biometric indicia of the user captured by the remote imaging device; and confirm authentication of the user based on the identifier code obtained remotely from the portable device.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a digital signal processing circuit (DSP), an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

Hence, in one aspect of the disclosure, processing circuit 804 may be a specialized processing circuit (e.g., an ASIC)) that is specifically designed and/or hard-wired to perform at least some of the algorithms, methods, and/or blocks described in FIGS. 2, 3, 4, 5, 6, and/or 7 (and/or FIGS. FIGS. 9, 10, 11, 12, 13, 14, 15, 16, 17, 18 and 19 discussed below). Thus, such a specialized processing circuit (e.g., ASIC) may be one example of a means for executing the algorithms, methods, and/or blocks described in FIGS. 2, 3, 4, 5, 6, and/or 7 (and/or FIGS. 9, 10, 11, 12, 13, 14, 15, 16, 17, 18 and 19, discussed below). The machine-readable storage medium may store instructions that when executed by a specialized processing circuit (e.g., ASIC) causes the specialized processing circuit to perform the algorithms, methods, and/or blocks described herein.

FIG. 9 is a flow diagram illustrating a method 900 operational on an authentication system such as access system that controls access to a secure facility or a secure financial system. At 902, the authentication system captures biometric indicia of a user by using a remote imaging device, such as by capturing an image of the face of the user with a video camera of a secure access system. At 904, the authentication system obtains an identifier code from a portable device of the user that identifies an authenticated user of the portable device, such as by capturing an image of a QR code that identifies the authenticated user and/or by inputting a coded audio signal, a coded infrared (IR) signal or a coded non-IR electromagnetic (EM) signal. At 906, the authentication system performs biometric authentication of the user based on the biometric indicia of the user captured by the remote imaging device, such as by analyzing the image of the face of the user captured by the aforementioned video camera. At 908, the authentication system confirms authentication of the user based on the identifier code obtained remotely from the portable device, such as by verifying that the user identified by the identifier code corresponds to the user identified via biometric facial identification.

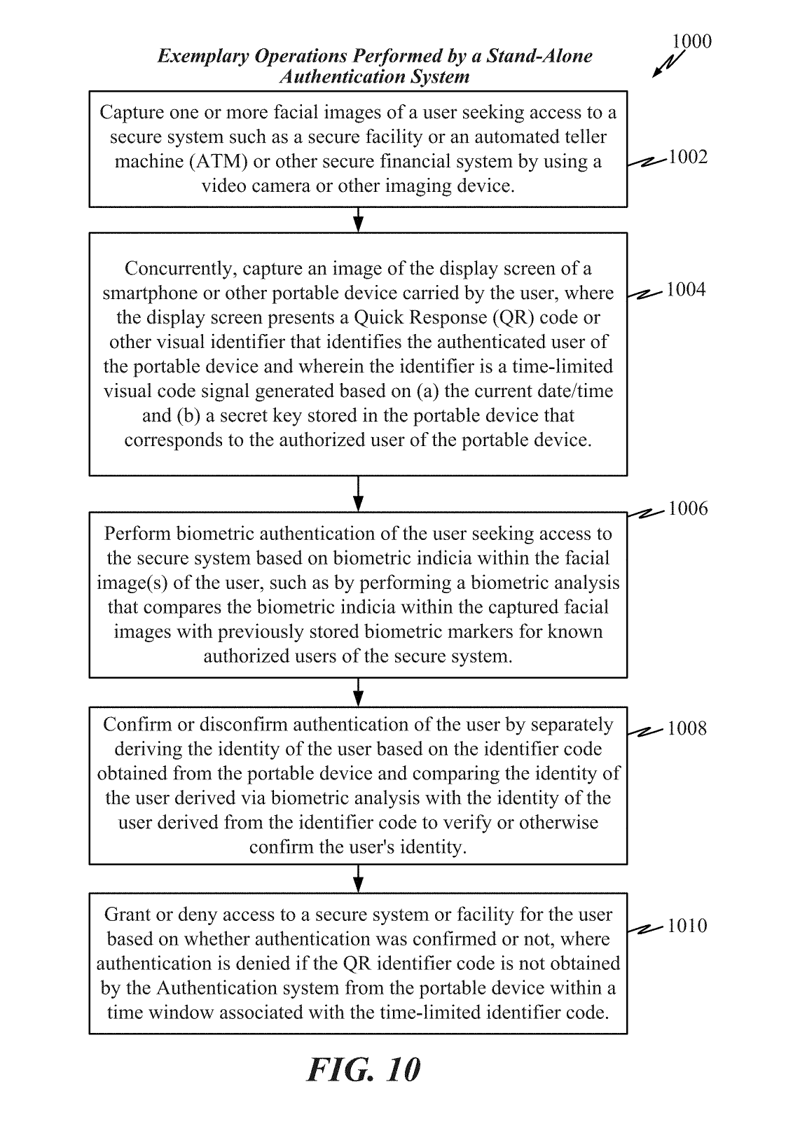

FIG. 10 is a flow diagram illustrating a method 1000 operational on a stand-alone authentication system (e.g. an authentication system that does not forward data to a remote system that performs the actual authentication). At 1002, the authentication system captures one or more facial images of a user seeking access to a secure system such as a secure facility or an ATM or other secure financial system by using a video camera or other imaging device. Concurrently, at 1004, the authentication system captures an image of the display screen of a smartphone or other portable device carried by the user, where the display screen presents a QR code or other visual identifier that identifies the authenticated user of the portable device, wherein the identifier is a time-limited visual code signal generated based on (a) the current date/time and (b) a secret key stored in the portable device that corresponds to the authorized user of the portable device. At 1006, the authentication system performs a biometric authentication of the user seeking access to the secure system based on biometric indicia within the facial image(s) of the user, such as by performing a biometric analysis that compares the biometric indicia within the captured facial images with previously stored biometric markers for known authorized users of the secure system. At 1008, the authentication system confirms authentication of the user seeking access to the secure system by separately deriving the identity of the user based on the identifier code obtained from the portable device and comparing the identity of the user derived from the biometric analysis with the identity of the user derived based on the identifier code to verify or otherwise confirm the user's identity. At 1010, the authentication system grants or denies access to a secure system or facility for the user based on whether authentication is confirmed or not, at 1008, where authentication is denied if the QR identifier code is not obtained by the authentication system from the portable device within a time window associated with the time-limited identifier code. As noted above, the time window may be as short as ten to twenty seconds but it might be set to longer values in the range of minutes or hours. In addition, as noted above, if access is initially denied, the authentication system may provide additional or alternative procedures for granting access to authorized users, such as by allowing them to enter a fingerprint into a fingerprint scanner of the local authentication system.

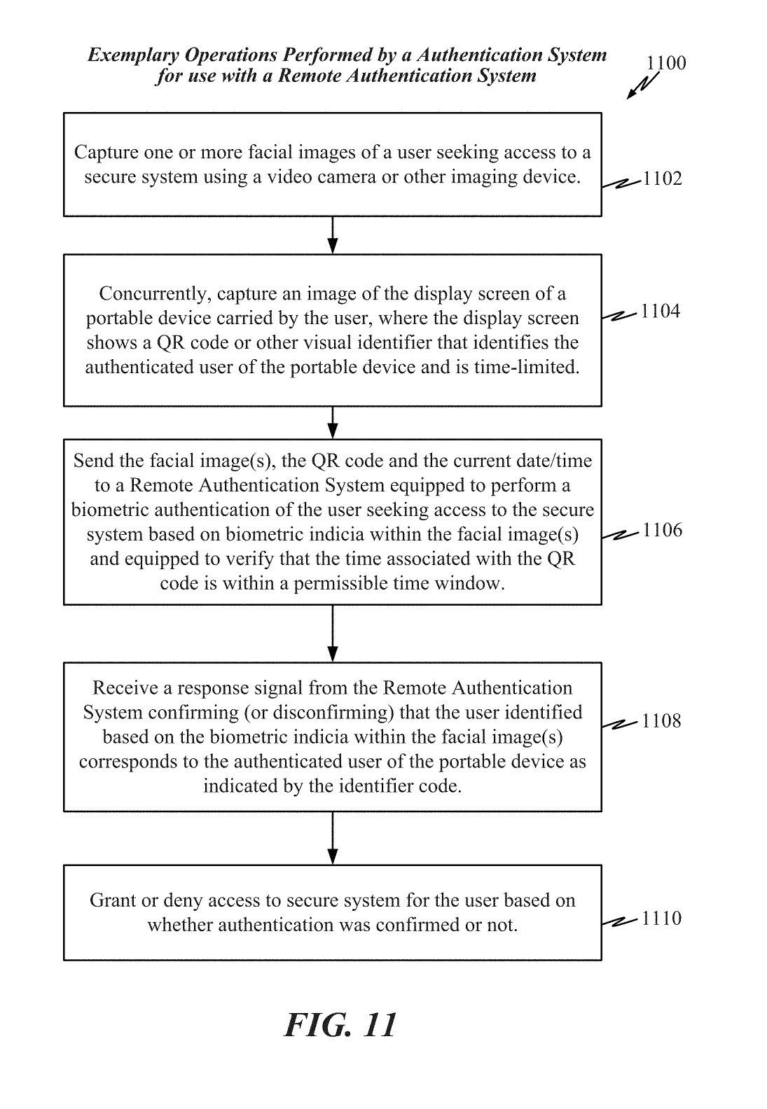

FIG. 11 is a flow diagram illustrating a method 1100 operational on an authentication system for use with a remote authentication system that performs the actual authentication. At 1102, the authentication system captures one or more facial images of a user seeking access to a secure system using a video camera or other imaging device. Concurrently, at 1104, the authentication system captures an image of the display screen of a portable device carried by the user, where the display screen shows a QR code or other visual identifier that identifies the authenticated user of the portable device and is time-limited. At 1106, the authentication system sends the facial image(s), the QR code and the current date/time to a remote authentication system equipped to perform a biometric authentication of the user seeking access to the secure system based on biometric indicia within the facial image(s) and equipped to verify that the time associated with the QR code is within a permissible time window. At 1108, the authentication system receives a response signal from the remote authentication system confirming (or disconfirming) that the user identified based on the biometric indicia within the facial image(s) corresponds to the authenticated user of the portable device as indicated by the identifier code. At 1110, the authentication system then grants or denies access to secure system for the user based on whether authentication was confirmed or not. Again, as already noted, if access is initially denied, the authentication system may provide additional or alternative procedures for granting access to authorized users.

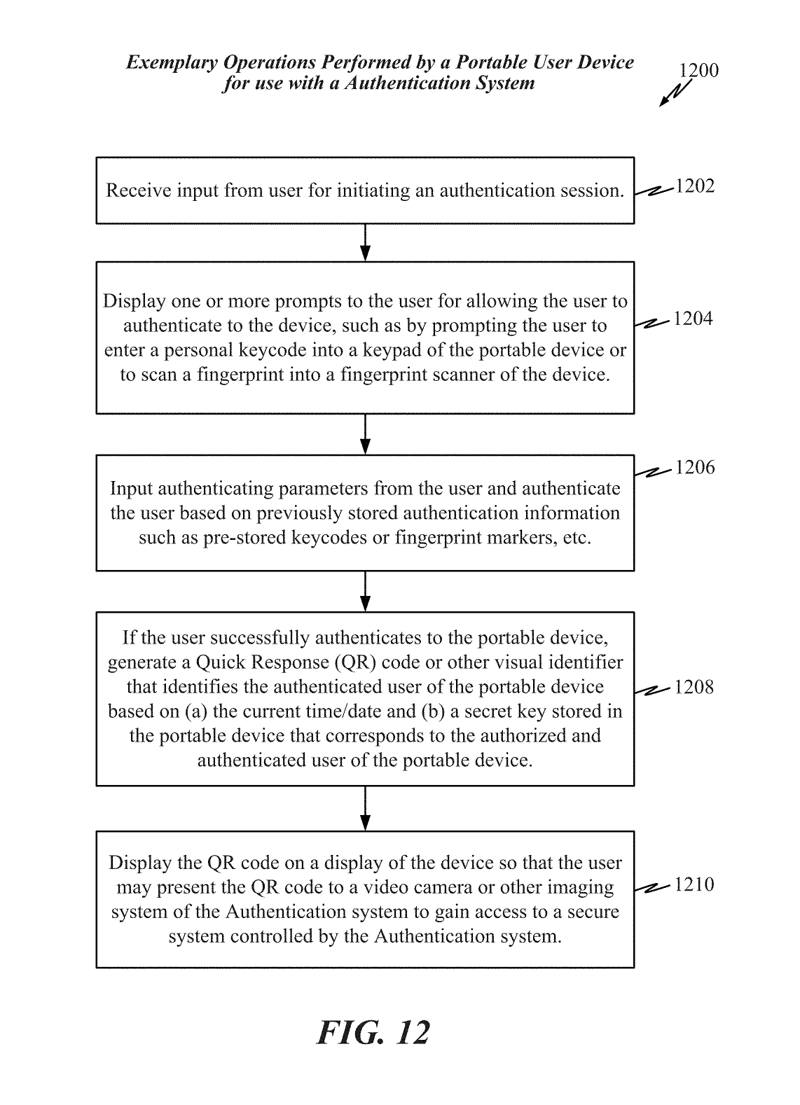

FIG. 12 is a flow diagram illustrating a method 1200 operational on a portable user device such as a smartphone for use with an authentication system. At 1102, the user device receives input from user for initiating an authentication session. For example, as the user approaches a secure facility equipped with an authentication system, the user enters commands into his or her portable device to initiate authentication. This might be done, for example, while queuing up to enter a secure installation or while waiting to access an ATM. At 1204, the user device displays one or more prompts to the user for allowing the user to authenticate to the device, such as by prompting the user to enter a personal keycode into a keypad of the portable device or to scan a fingerprint into a fingerprint scanner of the device. Other forms of authentication might include an iris scan or a sequence of unique gestures. In general, any suitable and reliable authentication procedure might be used. At 1206, the user device inputs authenticating parameters from the user (such as the fingerprint or keycode) and authenticates the user based on previously stored authentication information such as pre-stored keycodes or fingerprint markers, etc. At 1208, if the user successfully authenticates to the portable device, the portable device then generates a QR code or other visual identifier that identifies the authenticated user of the device based on (a) the current date/time and (b) a secret key stored in the portable device that corresponds to the authorized and authenticated user of the portable device. At 1210, the user portable device displays the QR code on its display so that the user may present the QR code to a video camera or other imaging system of the authentication system to gain access to a secure system controlled by the authentication system.

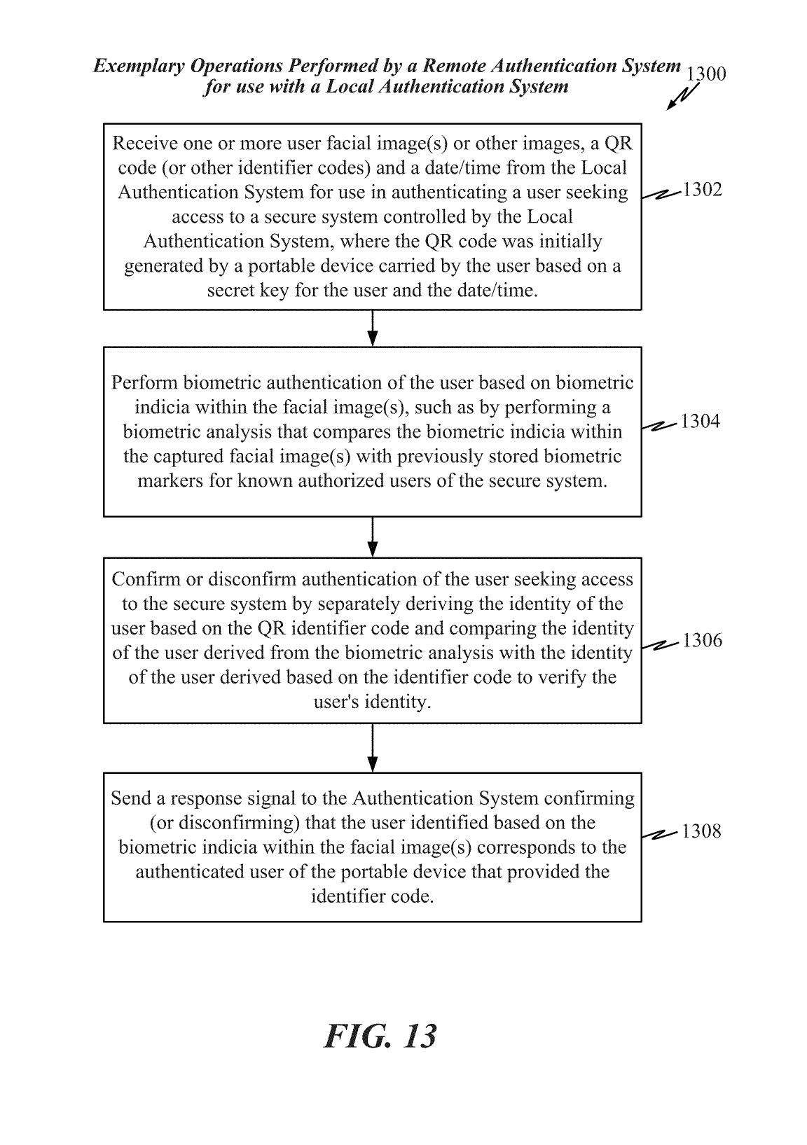

FIG. 13 is a flow diagram illustrating a method 1300 operational on a remote authentication system or server for use with a local authentication system. At 1302, the remote authentication system receives: one or more user facial image(s) or other images from which biometric indicia can be extracted; a QR code (or other identifier codes); and a date/time from the local authentication system for use in authenticating a user seeking access to a secure system controlled by the local authentication system, where the QR code was generated by a portable device carried by the user based on a secret key for the user and the date/time. At 1304, the remote authentication system performs biometric authentication of the user based on biometric indicia within the facial image(s), such as by performing a biometric analysis that compares the biometric indicia within the captured facial image(s) with previously stored biometric markers for known authorized users of the secure system. At 1306, the remote authentication system confirms or disconfirms authentication of the user seeking access to the secure system by separately deriving the identity of the user based on the QR identifier code and comparing the identity of the user derived from the biometric analysis with the identity of the user derived based on the identifier code to verify the user's identity. At 1308, the remote authentication system sends a response signal to the authentication system confirming (or disconfirming) that the user identified based on the biometric indicia corresponds to the authenticated user of the portable device that provided the identifier code. Additionally, if the individual seeking access is denied access, the system may send a suitable notification signal or warning signal to the appropriate authorities or personnel, particularly if the individual is seeking access the a secure facility.

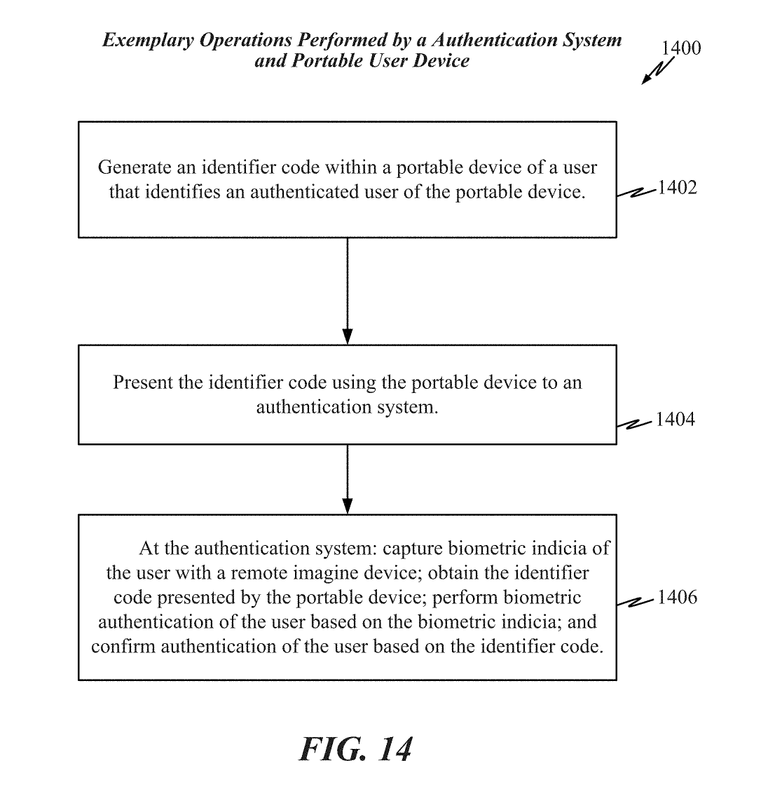

FIG. 14 is a flow diagram illustrating a method 1400 performed cooperatively by an authentication system and a portable user device. At 1402, the portable device of a user generates an identifier code within the portable device of the user that identifies an authenticated user of the portable device. At 1404, the identifier code is presented to an authentication system using the portable device. The authentication system, at 1406, then captures biometric indicia of the user with a remote imagine device, obtains the identifier code presented by the portable device, performs biometric authentication of the user based on the biometric indicia, and confirms authentication of the user based on the identifier code.

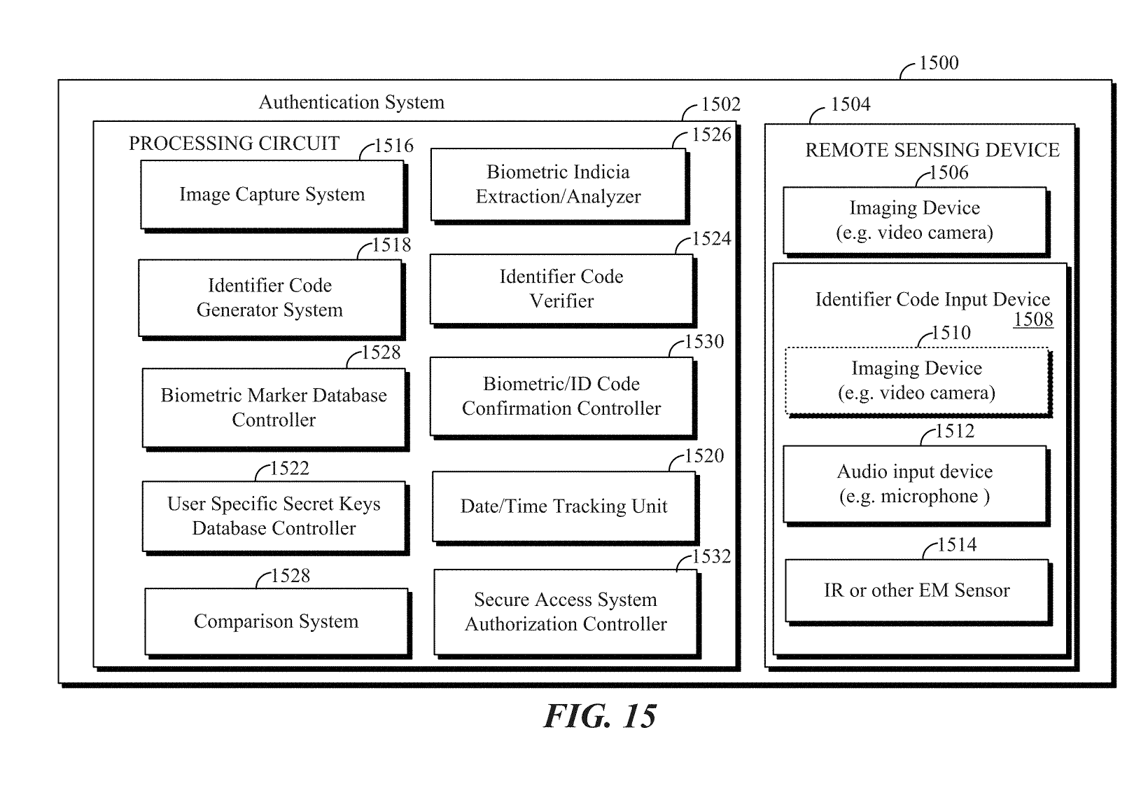

FIG. 15 is a block diagram illustrating selected and exemplary components of an authentication system 1500. The authentication system includes a processing circuit 1502 and a remote sensing device 1504. The remote sensing device includes, in this example, an imaging device 1506 (such as a video camera) operative to remotely capture biometric indicia of a user and an identifier code input device 1508 operative to remotely obtain an identifier code from a portable device of a user that identifies an authenticated user of the portable device. The identifier code input device 1508 may include its own imaging device 1510 or may use imaging device 1506. (Imagining device 1510 is shown in dashed lines since it may be the same device as 1506.) In this example, the identifier code input device 1508 also includes an audio input device 1512 such as a microphone and an IR or other EM sensor 1514. In many examples, the only component of the remote sensing device 1504 will be a single video camera. The audio and IR/EM sensors are shown since some implementations may exploit such devices.

The processing circuit 1510 includes, in this example, an imaging capture device 1516 operative to capture an image of a user with the remote imaging device and to capture an image of a display of a portable device of the user with the remote imaging device, where the display of the portable device presenting a visual identifier code that identifies the authenticated user of the portable device. An identifier code generator system 1518 is operative to generate a QR code or other identifier code for comparison against an identifier code obtained from the portable device of the user. Generation of the identifier code by system 1518 may exploit the date/time as tracked by a date/time tracking unit 1520 and one or more keys stored in a user specific secret key database under the control of a user specific secret key database controller 1522. An identifier code verifier 1524 is operative to compare the identifier code generated by identifier code generator system 1518 against the identifier code obtained from the user's portable device to verify that the identifier code is valid for the user. That is, the identifier code verifier 1524 separately derives the identity of the user based on the identifier code obtained from the portable device.

A biometric indicia extraction/analyzer 1526 is operative to extract biometric indicia for the user from the images obtained by the imaging device 1516 and to analyze the indicia to identify the user based on biometric markers stored in a biometric marker database under the control of a biometric marker database controller 1528. A comparison system 1528 is operative to compare the identity of the user derived from the biometric indicia with the identity of the user derived based on the identifier code to confirm the user's identity. A biometric/ID code confirmation controller 1530 then confirms authentication of the user based (at least in part) on the identifier code obtained remotely from the portable device and on the identity of the user as derived from the biometric analyses. A secure access system authorization controller 1532 then grants or denies access to a system or facility that is controlled by the authentication system 1500 based on whether the user has been properly authenticated.

As already explained, all or some of the components of an authentication system may be split between different systems such as a local authentication system and a remote authentication system. Depending upon the implementation, the functions and operations of the above-described devices and components may be performed by other suitable components that perform the same or similar functions. As such, in some examples, an apparatus, system or device is provided that includes: a means for processing and a means for remote sensing. The means for remote sensing may include means for imaging that includes means for remotely capturing biometric indicia of a user and means for remotely obtaining an identifier code from a portable device of a user that identifies an authenticated user of the portable device. Means for inputting audio signals and means for inputting IR or other EM signals may be provided.

The means for processing includes, in some examples, means for capturing images that is operative to capture an image of a user with the remote imaging device and to capture an image of a display of a portable device of the user, where the display of the portable device presenting a visual identifier code that identifies the authenticated user of the portable device. Identifier code generator means may be provided for generating a QR code or other identifier code for comparison against an identifier code obtained from the portable device of the user. Identifier code verifier means may be provided for comparing the identifier code against an identifier code obtained from the user's portable device to verify that the identifier code is valid for the user. A biometric indicia extraction/analyzer means may be provided for extracting biometric indicia for the user from the images obtained by an imaging device and for analyzing the indicia to identify the user based on biometric markers stored in a biometric marker database. A comparison means is provided for comparing the identity of the user derived from the biometric indicia with the identity of the user derived based on the identifier code to confirm the user's identity. Biometric/ID code confirmation control means may be provided for confirming authentication of the user based (at least in part) on the identifier code obtained remotely from the portable device and on the identity of the user as derived from the biometric analyses. Secure access system authorization control means may be provided for granting or denying access to a system or facility that is controlled by the authentication system based on whether the user has been authenticated.

Still further, depending upon the implementation, the functions and operations of the above-described devices and components may be implemented as instructions for use with a machine-readable storage medium. As such, in some examples, instructions are provided that include: instructions for processing and instructions for remote sensing. The instructions for remote sensing may include instructions for imaging that includes instructions for remotely capturing biometric indicia of a user and instructions for remotely obtaining an identifier code from a portable device of a user that identifies an authenticated user of the portable device. Instructions for inputting audio signals and means for inputting IR or other EM signals may be provided. The instructions for processing include, in some examples, instructions for capturing images that are operative to capture an image of a user with the remote imaging device and to capture an image of a display of a portable device of the user, where the display of the portable device presenting a visual identifier code that identifies the authenticated user of the portable device. Identifier code generator instructions may be provided for generating a QR code or other identifier code for comparison against an identifier code obtained from the portable device of the user. Identifier code verifier instructions may be provided for comparing the identifier code against an identifier code obtained from the user's portable device to verify that the identifier code is valid for the user. Biometric indicia extraction/analyzer instructions may be provided for extracting biometric indicia for the user from the images obtained by an imaging device and for analyzing the indicia to identify the user based on biometric markers stored in a biometric marker database. Comparison instructions may be provided for comparing the identity of the user derived from the biometric indicia with the identity of the user derived based on the identifier code to confirm the user's identity. Biometric/ID code confirmation control instructions may be provided for confirming authentication of the user based (at least in part) on the identifier code obtained remotely from the portable device and on the identity of the user as derived from the biometric analyses. Secure access system authorization control instructions may be provided for granting or denying access to a system or facility that is controlled by the authentication system based on whether the user has been authenticated.

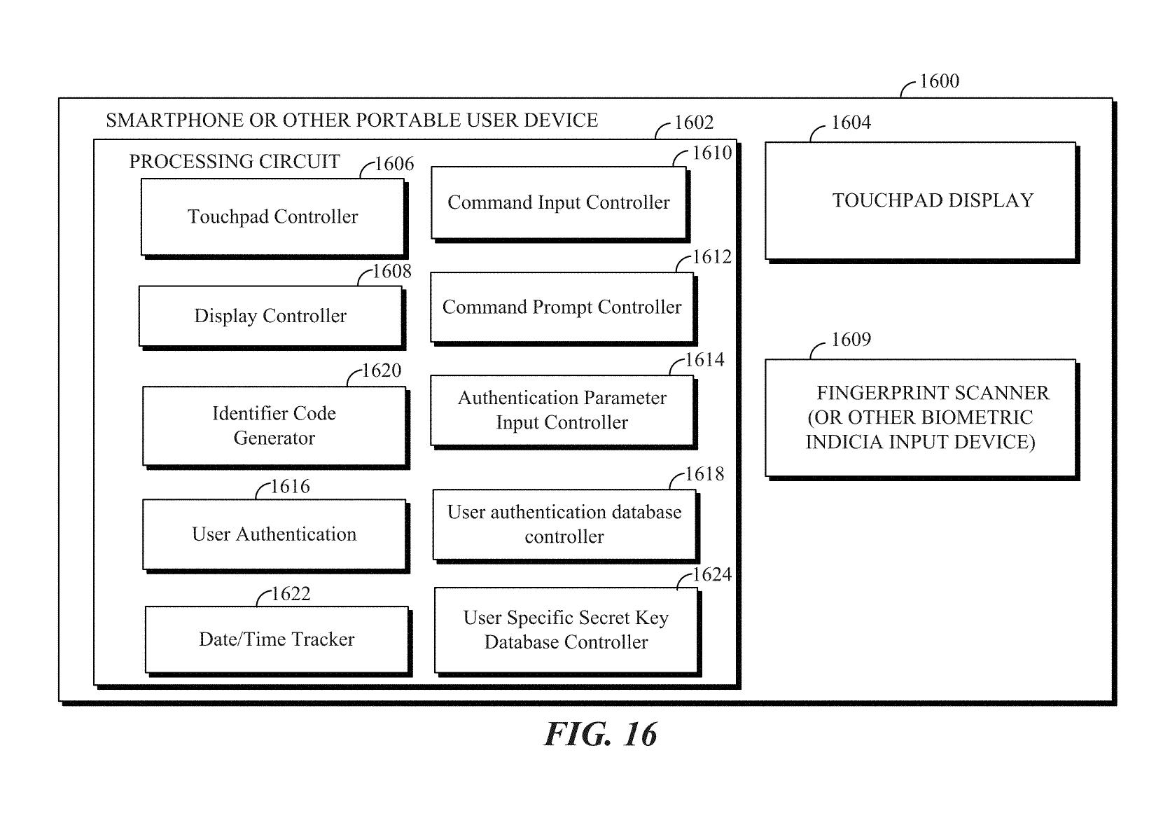

FIG. 16 is a block diagram illustrating selected and exemplary components of a smartphone or other portable user device 1600. The smartphone includes a processing circuit 1602 and a touchpad display device 1604 under the control of a touchpad input controller 1606 and a display controller 1608. A fingerprint scanner or other biometric indicia input device 1609 is also provided. (Other forms of biometric indicia input device might include an iris scanner or an accelerometer for inputting a sequence of unique gestures.) A command input controller 1610 of the processing circuit 1602 is operative to receive input from a user (via the touchpad display 1604) for initiating an authentication session. A command prompt controller 1612 displays one or more prompts to the user via the touchpad display for allowing the user to authenticate to the device, such as by prompting the user to enter a personal keycode into a keypad of the portable device or to scan a fingerprint into the fingerprint scanner 1609. An authentication parameter input controller 1614 controls the input of various authenticating parameters from the user (such as the fingerprint or keycode). A user authentication system 1616 authenticates the user based on previously stored authentication information such as pre-stored keycodes or fingerprint markers, etc., that are stored in a user authentication database under the control of a user authentication database controller 1618. If the user successfully authenticates to the portable device, an identification code generator 1620 generates a QR code or other identifier that identifies the authenticated user of the device based on (a) the current date/time as determined by a date/time tracker 1622 and (b) a secret key stored in the portable device that corresponds to the authorized and authenticated user of the portable device. The secret key may be stored in a suitable database or register under the control of a user specific secret key database controller 1624. The display controller 1608 then controls the touchpad display to display the QR code of other identification code so that the user may present the code to a video camera or other imaging system of an authentication system to gain access to a secure system controlled by the authentication system.

Depending upon the implementation, the functions and operations of the above-described devices and components may be performed by other suitable components that perform the same or similar functions. As such, in some examples, an apparatus, system or device is provided that includes: a means for processing and means for display that operates under the control of a means for controlling a touchpad and a means for controlling the display. Means for scanning a fingerprint or means for inputting other biometric indicia may also be provided. Means for inputting commands may be provided for receiving input from a user for initiating an authentication session. Means for prompting the user may be provided for displaying one or more prompts to the user for allowing the user to authenticate to the device, such as by prompting the user to enter a personal keycode into a keypad of the portable device or to scan a fingerprint into a fingerprint scanner. Means for inputting authentication parameters may be provided for controlling the input of various authenticating parameters from the user (such as the fingerprint or keycode). Means for authenticating may be provided for authenticating the user based on previously stored authentication information such as pre-stored keycodes or fingerprint markers, etc., that are stored in a user authentication database. A means for generating an identification code may be provided for generating a QR code or other identifier that identifies the authenticated user of the device based on (a) the current date/time as determined by a date/time tracker 1622 and (b) a secret key stored in the portable device that corresponds to the authorized and authenticated user of the portable device.

Still further, depending upon the implementation, the functions and operations of the above-described devices and components may be implemented as instructions for use with a machine-readable storage medium. As such, in some examples, instructions are provided that include: instructions for processing and instructions for displaying including instructions for controlling a touchpad and instructions for controlling the display. Instructions for scanning a fingerprint or instructions for inputting other biometric indicia may also be provided. Instructions for inputting commands may be provided for receiving input from a user for initiating an authentication session. Instructions for prompting the user may be provided for displaying one or more prompts to the user for allowing the user to authenticate to the device, such as by prompting the user to enter a personal keycode into a keypad of the portable device or to scan a fingerprint into a fingerprint scanner. Instructions for inputting authentication parameters may be provided for controlling the input of various authenticating parameters from the user (such as the fingerprint or keycode). Instructions for authenticating may be provided for authenticating the user based on previously stored authentication information such as pre-stored keycodes or fingerprint markers, etc., that are stored in a user authentication database. Instructions for generating an identification code may be provided for generating a QR code or other identifier that identifies the authenticated user of the device based on (a) the current date/time as determined by a date/time tracker 1622 and (b) a secret key stored in the portable device that corresponds to the authorized and authenticated user of the portable device.

### Alternative Exemplary Systems and Methods

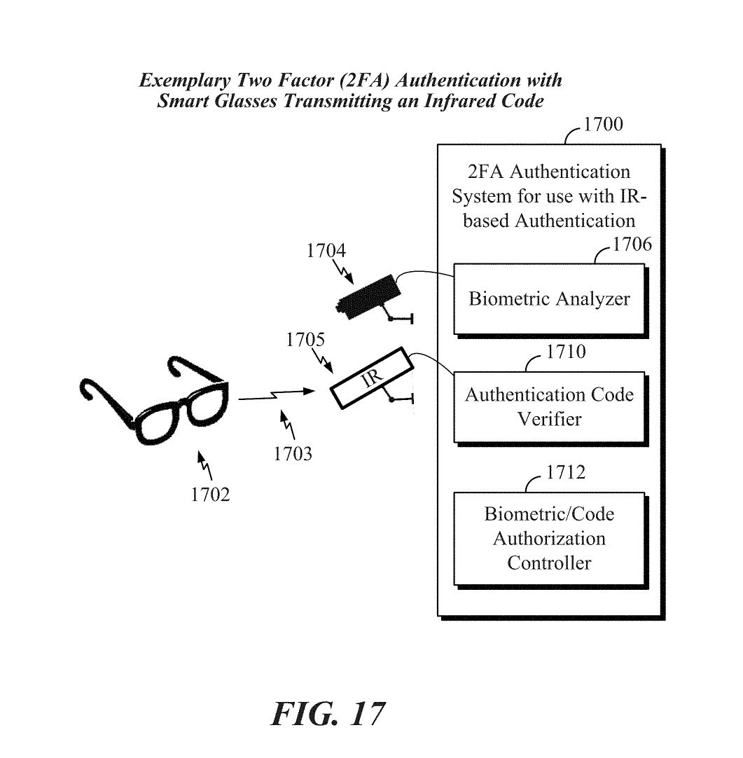

FIG. 17 illustrates an alternative 2FA system 1700 employing visual biometric authentication along with time-limited code-based authentication wherein the time limited code is periodically or continuously transmitted as an IR signal by smart glasses worn by a user or by some other suitable portable device. The time-limited code may be generated for the user based on a security key stored within a processor of the smart glasses device. In this example, a user (not separately shown in FIG. 17) who is seeking access to one or more secure facilities or systems wears smart glasses 1702 that periodically or continuously transmits or broadcasts time-limited authentication codes as IR signals, which may be automatically sensed by any suitable-equipped authentication system that the user approaches. As the user approaches, he or she is imaged by a video camera 1704 of the authentication system, which relays an image of the user to a biometric analyzer 1706 of the authentication system that seeks to confirm the identity of the user as an authorized user based on biometric indicia within the image of the user. The authentication system 1700 also receives the time-limited authentication code transmitted by the smart glasses 1702 as an IR signal 1703, with the IR signal received by an IR sensor 1705 (which may be a component of the video camera 1704). The code is relayed to a code verifier 1710 that seeks to confirm the identity of the user based on the code (e.g. by verifying that the code corresponds the same user identified by the biometric analyzer). A biometric/code authorization controller 1712 then determines whether the user is authorized to access the secure facility or system based on the biometric analysis, the code verification, and whether code is sufficiently fresh (i.e. whether the code was received by system 1700 within a permissible time-window).

Alternate forms of secondary authentication other than an IR code include coded radio signals or the like. Moreover, as with the examples described above, the local authentication system (such as an ATM) may operate in conjunction with a remote system that performs the actual authentication. For example, the local system may forward the video camera images to a remote system that performs the biometric analysis and extracts the authentication code from the IR signal to authenticate the user. The remote system sends a suitable message to the local system that either confirms or disconfirms authentication. In this manner, each individual local authentication system need not be equipped to perform all aspects of the overall authentication process.

In practice, when using a system such as the one of FIG. 17, the user may perform an initial setup procedure using the smart glasses that generates and exchanges suitable keys with the authentication system. Thereafter, the smart glasses device periodically or continuously generates and transmits a time-based code using its stored key along with the current date/time. For example, the device may be programmed to transmit a new code once every one to ten seconds. The user then wears the smart glasses, which periodically or continuously transmits the latest code to any authentication devices in the vicinity for 2F authentication. This may be particularly advantageous for use with employees within secure facilities who require frequent but intermittent access to various different secured devices, systems or rooms, where the methods described above involving the use of a smartphone might be cumbersome or inefficient. In some examples, rather than using smart glasses, an employee badge may be equipped to generate and transmit the coded IR signal. To avoid undue consumption of battery power within such devices, the device may be equipped to allow the user to easily activate or deactivate the IR transmission.

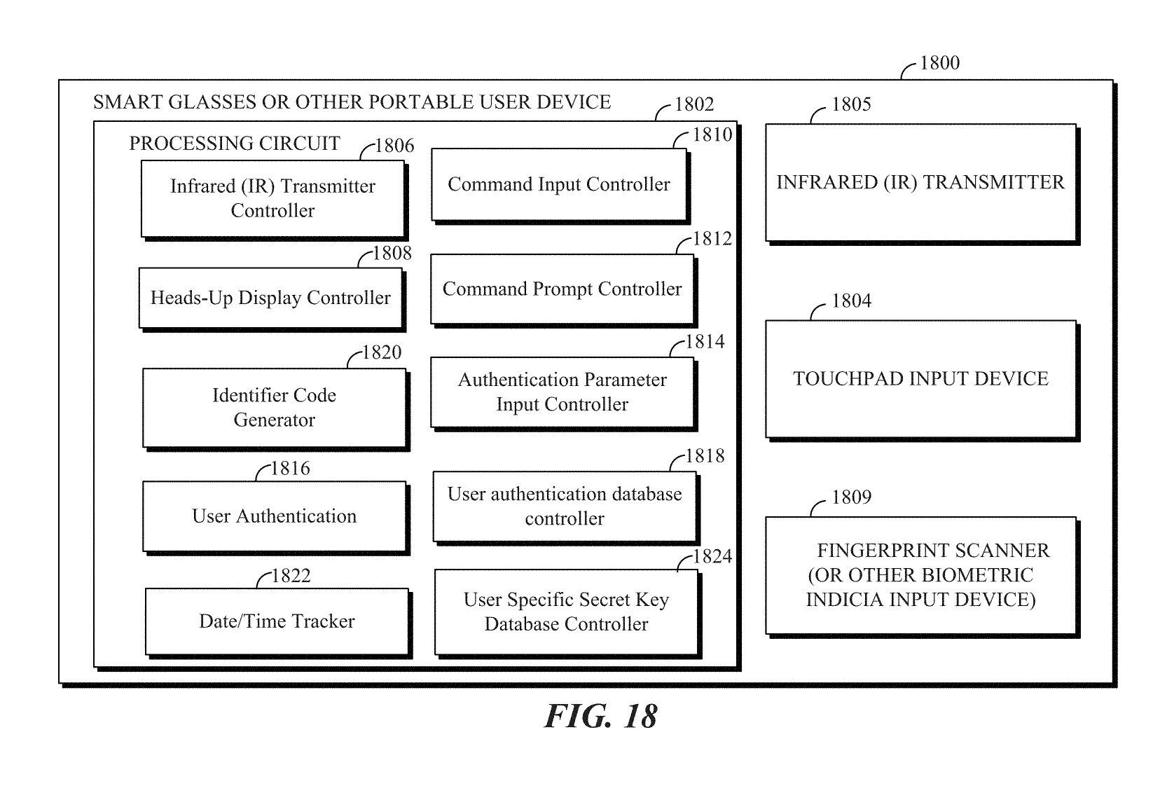

FIG. 18 is a block diagram illustrating selected and exemplary components of smart glasses or other portable user device 1800 that may be used in connection with the system of FIG. 17. The smart glasses includes a processing circuit 1802, a touchpad input device 1804 and an IR transmitter 1805 that operates under the control of an IR transmitter controller 1806. The processor also includes a “heads-up” display controller 1808 for displaying information to the user via the lenses of the smart glasses. A fingerprint scanner or other biometric indicia input device 1809 is also provided for allowing the user to authenticate himself or herself to the smart glasses. The fingerprint scanner 1809 may be a component of the touchpad input device 1804. Other biometric indicia input devices might include iris scanners or accelerometers for inputting a sequence of unique gestures.

A command input controller 1810 is operative to receive input from the user (via the touchpad display 1804) for initiating an authentication session. A command prompt controller 1812 displays one or more prompts to the user via the heads-up display, such as by prompting the user to place a finger or thumb against the fingerprint scanner 1809 under the control of an authentication parameter input controller 1814. A user authentication system 1816 authenticates the user based on previously stored authentication information such as pre-stored fingerprint markers, etc., maintained in a user authentication database under the control of a user authentication database controller 1818. If the user successfully authenticates to the smart glasses, an identification code generator 1820 then periodically or continuously generates an authentication code based on (a) the current date/time as determined by a date/time tracker 1822 and (b) a secret key stored in the device that corresponds to the authorized and authenticated user of the device. The secret key may be stored in a database or memory register under the control of a user specific secret key database controller 1824. The IR transmitter controller 1806 then controls the IR transmitter 1805 to periodically or continuously transmit the code as an IR signal so that the user may gain access to any secure systems equipped and programmed to recognize the particular user based on biometrics such as facial recognition biometrics.

Depending upon the implementation, the functions and operations of the above-described devices and components may be performed by other suitable components that perform the same or similar functions. As such, in some examples, an apparatus, system or device is provided that includes: means for controlling the generation of coded IR signals for transmission, means for transmitting coded IR signals, means for controlling a heads-up display, etc. Still further, depending upon the implementation, the functions and operations of the above-described devices and components may be implemented as instructions for use with a machine-readable storage medium. As such, in some examples, instructions are provided that include: instructions for controlling the generation of coded IR signals for transmission, instructions for transmitting coded IR signals, instructions for controlling a heads-up display, etc. Instructions may be provided that cause the processing circuit to confirm authentication of a user by: separately deriving the identity of the user based on the identifier code obtained from the portable device; and comparing an identity of the user derived from the biometric indicia with the identity of the user derived based on the identifier code to confirm the user's identity. Instructions may also be provided for use with systems the identifier code is a time-limited identifier code having an IR signal that is continuously or periodically transmitted and wherein the instructions are operative to deny authentication to a user if the identifier code is not obtained from the portable device within a time window associated with the time-limited identifier code.

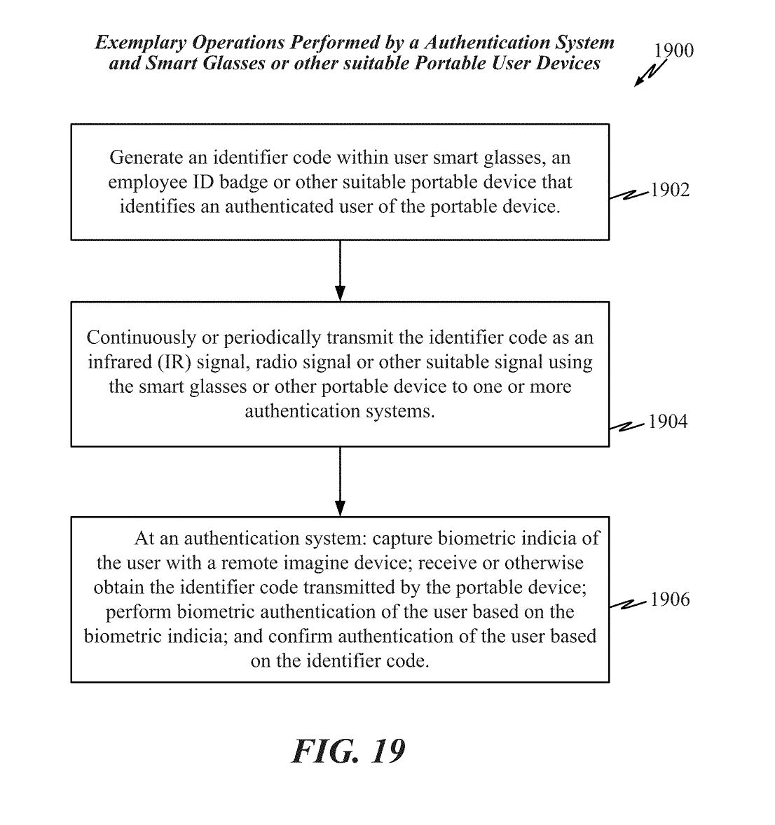

FIG. 19 is a flow diagram illustrating a method 1900 performed cooperatively by an authentication system and smart glasses or other suitable portable user devices. At 1902, the smart glasses or other portable device of the user generates an identifier code that identifies an authenticated user of the portable device. At 1904, the identifier code is continuously or periodically transmitted to an authentication system by the portable device as an IR signal, radio signal or other suitable signal. The authentication system, at 1906, captures biometric indicia of the user with a remote imagine device, receives or otherwise obtains the identifier code transmitted by the portable device, performs biometric authentication of the user based on the biometric indicia, and confirms authentication of the user based on the identifier code.

In addition, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, a storage medium may represent one or more devices for storing data, including read-only memory (ROM), random access memory (RAM), magnetic disk storage mediums, optical storage mediums, flash memory devices, and/or other machine readable mediums for storing information. The term “machine readable medium” includes, but is not limited to portable or fixed storage devices, optical storage devices, wireless channels and various other mediums capable of storing, containing, or carrying instruction(s) and/or data.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

Those of skill in the art would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

What is claimed is:

1. A method for use by an authentication system for authenticating a user, comprising:
capturing biometric indicia of a user by using a remote imaging device;
obtaining an identifier code from a portable device of the user that identifies an authenticated user of the portable device, the identifier code obtained remotely;
performing biometric authentication of the user based on the biometric indicia of the user captured by the remote imaging device; and
confirming authentication of the user based on the identifier code obtained remotely from the portable device.

2. The method of claim 1, wherein capturing biometric indicia of the user includes capturing an image of the user with the remote imaging device and wherein obtaining the identifier code comprises capturing an image of a display of the portable device with the remote imaging device, the display of the portable device presenting a visual identifier code that identifies the authenticated user of the portable device.

3. The method of claim 2, wherein the visual identifier code that identifies the authenticated user of the portable device is a Quick Response (QR) code.

4. The method of claim 2, wherein the visual identifier code and the image of the user are captured concurrently by the authentication system.

5. The method of claim 2, wherein performing biometric authentication includes deriving the identity of the user from biometric indicia in the captured image of the user.

6. The method of claim 1, wherein capturing the biometric indicia of the user and obtaining the identifier code from the portable device are performed by local components of the authentication system and wherein performing the biometric authentication and confirming the authentication are performed by remote components of the authentication system based on information relayed from the local components.

7. The method of claim 1, wherein confirming authentication of the user based on the identifier code comprises:
separately deriving the identity of the user based on the identifier code obtained from the portable device; and
comparing an identity of the user derived from the biometric indicia with the identity of the user derived based on the identifier code to confirm the user's identity.

8. The method of claim 1, wherein the identifier code obtained from the portable device is a time-limited identifier code and wherein authentication is denied if the identifier code is not obtained from the portable device within a time window associated with the time-limited identifier code.

9. The method of claim 1, wherein the identifier code obtained from the portable device is based on a security key associated with the authenticated user of the portable device that is stored in the portable device.

10. The method of claim 1, wherein the identifier code obtained from the portable device includes one or more of: a coded visual signal; a coded audio signal; a coded infrared (IR) signal; and a coded non-IR electromagnetic (EM) signal.

11. The method of claim 1, wherein the identifier code is continuously or periodically transmitted from the portable device.

12. The method of claim 11, wherein the identifier code is a time-limited identifier code comprising an infrared (IR) signal and wherein authentication is denied if the identifier code is not obtained from the portable device within a time window associated with the time-limited identifier code.

13. The method of claim 1, wherein the portable device is a smartphone, a smart watch, a smart eyeglass device, a communications device, a mobile phone, a personal digital assistant, user equipment (UE) and/or a tablet computer.

14. An authentication system, comprising:
an imaging device operative to remotely capture biometric indicia of a user;
an identifier code input device operative to remotely obtain an identifier code from a portable device of the user that identifies an authenticated user of the portable device; and
a processing circuit operative to
perform biometric authentication of the user based on the biometric indicia of the user captured by the imaging device, and
confirm authentication of the user based on the identifier code obtained from the portable device.

15. The authentication system of claim 14, wherein the imaging device is operative to capture an image of the user and wherein the identifier code input device is operative to use the imaging device to capture an image of a display of the portable device that presents a visual identifier code that identifies the authenticated user of the portable device.

16. The authentication system of claim 14, wherein the processing circuit confirms authentication of the user by:
separately deriving the identity of the user based on the identifier code obtained from the portable device; and
comparing an identity of the user derived from the biometric indicia with the identity of the user derived based on the identifier code to confirm the user's identity.

17. The authentication system of claim 14, wherein the identifier code is a time-limited identifier code comprising an infrared (IR) signal that is continuously or periodically transmitted and wherein authentication is denied by the processing circuit if the identifier code is not obtained from the portable device within a time window associated with the time-limited identifier code.

18. A non-transitory machine-readable storage medium having one or more instructions which when executed by a processing circuit causes the processing circuit to:
capture biometric indicia of a user by using a remote imaging device;
obtain an identifier code from a portable device of the user that identifies an authenticated user of the portable device, the identifier code obtained remotely;
perform biometric authentication of the user based on the biometric indicia of the user captured by the remote imaging device; and
confirm authentication of the user based on the identifier code obtained remotely from the portable device.

19. The non-transitory machine-readable storage medium of claim 18, wherein the one or more instructions which when executed by a processing circuit causes the processing circuit to confirm authentication of the user by:
separately deriving the identity of the user based on the identifier code obtained from the portable device; and
comparing an identity of the user derived from the biometric indicia with the identity of the user derived based on the identifier code to confirm the user's identity.

20. The non-transitory machine-readable storage medium of claim 18, wherein the identifier code is a time-limited identifier code comprising an infrared (IR) signal that is continuously or periodically transmitted and wherein the instructions are operative to deny authentication if the identifier code is not obtained from the portable device within a time window associated with the time-limited identifier code.
